(19) United States
(12) Patent Application Publication
(10) Pub. No.: US 2016/0364376 A1
(43) Pub. Date: Dec. 15, 2016

(54) INFORMATION PROCESSING APPARATUS, NETWORK SYSTEM, AND NON-TRANSITORY COMPUTER READABLE MEDIUM

(71) Applicant: FUJI XEROX CO., LTD., Tokyo (JP)

(72) Inventor: Genki OSADA, Kanagawa (JP)

(73) Assignee: FUJI XEROX CO., LTD., Tokyo (JP)

(21) Appl. No.: 14/957,205

(22) Filed: Dec. 2, 2015

(30) Foreign Application Priority Data
Jun. 10, 2015 (JP) 2015-117141

(51) Int. Cl. G06F 17/27; G06F 17/30; G06F 17/22

(52) U.S. Cl. CPC G06F 17/272; G06F 17/2247; G06F 17/30905

(57) ABSTRACT

An information processing apparatus includes a memory that stores, on a per webpage basis, an assumed response pattern representing a document structure of a response to be generated by a web server in response to a webpage browsing request, through parsing of an assumed description of the response, a generation unit that generates a response pattern representing a document structure of a response generated by the web server in response to a webpage browsing request from a client, through parsing of a description of the response, and a transmission controller that performs control such that if the response pattern generated by the generation unit matches a form of an assumed response pattern stored in the memory in association with a target webpage of the webpage browsing request from the client, the response generated by the web server in response to the webpage browsing request is transmitted to the client.

### CROSS-REFERENCE TO RELATED APPLICATIONS

This application is based on and claims priority under 35 USC 119 from Japanese Patent Application No. 2015-117141 filed Jun. 10, 2015.

### BACKGROUND

### (i) Technical Field

The present invention relates to an information processing apparatus, a network system, and a non-transitory computer readable medium.

### (ii) Related Art

Techniques of attacks through the Internet include a cross-site scripting attack (hereinafter, referred to as an XSS attack). In the XSS attack, a malicious third party uses a web site having a security weak point (vulnerability) and causes a malicious program to infiltrate on a web site visitor (client terminal), and thereby an information leak or a malfunction of the client terminal occurs.

### SUMMARY

According to an aspect of the invention, there is provided an information processing apparatus including a memory, a generation unit, and a transmission controller. The memory stores, on a per webpage basis, an assumed response pattern representing a document structure of a response that is to be generated by a web server in response to a webpage browsing request and that is to be described in a markup language, the assumed response pattern being generated as a result of parsing an assumed description of the response. The generation unit generates a response pattern representing a document structure of a response that is generated by the web server in response to a webpage browsing request transmitted from a client and that is described in the markup language, the response pattern being generated as a result of parsing a description of the response. The transmission controller performs control such that in a case where the response pattern generated by the generation unit matches a form of an assumed response pattern stored in the memory in association with a webpage that is a target of the webpage browsing request transmitted from the client, the response generated by the web server in response to the webpage browsing request transmitted from the client is transmitted to the client.

### BRIEF DESCRIPTION OF THE DRAWINGS

An exemplary embodiment of the present invention will be described in detail based on the following figures, wherein:

FIG. 1 is a block configuration diagram illustrating an inspection device in an exemplary embodiment of an information processing apparatus according to the present invention;

FIG. 2 is a hardware configuration diagram of a computer serving as the inspection device in the exemplary embodiment;

FIG. 3 illustrates an example of the data structure of an entry point map stored in an entry-point-map memory in the exemplary embodiment;

FIG. 4 is a flowchart illustrating an entry-point-map generation process in the exemplary embodiment;

FIG. 5 is a flowchart illustrating a digest generation process in the exemplary embodiment;

FIG. 6A illustrates an example of descriptions of an assumed response;

FIG. 6B illustrates an example of an assumed digest generated from the assumed response in FIG. 6A;

FIG. 7 is a flowchart illustrating a document object model (DOM)-structure-pattern generation process in the exemplary embodiment;

FIG. 8 is a flowchart illustrating an inspection process performed by the inspection device in the exemplary embodiment;

FIG. 9A illustrates an example of descriptions of a real response;

FIG. 9B illustrates an example of a real digest generated from the real response in FIG. 9A;

FIG. 10A illustrates an example of descriptions of an assumed response having a repeating pattern;

FIG. 10B illustrates an assumed digest generated from the assumed response in FIG. 10A;

FIG. 10C illustrates an assumed digest expressed by encoding the assumed digest in FIG. 10B;

FIG. 10D illustrates an example of an assumed digest described in such a manner that a repeated part included in FIG. 10C is compressed;

FIG. 10E illustrates another example of the assumed digest described in such a manner that the repeated part included in FIG. 10C is compressed;

FIG. 10F illustrates an example of an assumed digest obtained by decoding the assumed digest in FIG. 10D;

FIG. 10G illustrates another example of the assumed digest obtained by decoding the assumed digest in FIG. 10E;

FIG. 11A illustrates another example of the descriptions of an assumed response having a repeating pattern;

FIG. 11B illustrates an assumed digest generated from the assumed response in FIG. 11A;

FIG. 11C illustrates an assumed digest expressed by encoding the assumed digest in FIG. 11B;

FIG. 11D illustrates an example of an assumed digest obtained by decoding the assumed digest in FIG. 11C;

FIG. 12A illustrates an example of descriptions of an assumed response having a fixed description part and a variable description part;

FIG. 12B illustrates an assumed digest generated from the assumed response in FIG. 12A;

FIG. 13A illustrates an example of descriptions of a real response having a fixed description part and a variable description part; and

FIG. 13B illustrates a real digest generated from the real response in FIG. 13A.

### DETAILED DESCRIPTION

Hereinafter, an exemplary embodiment of the present invention will be described with reference to the drawings.

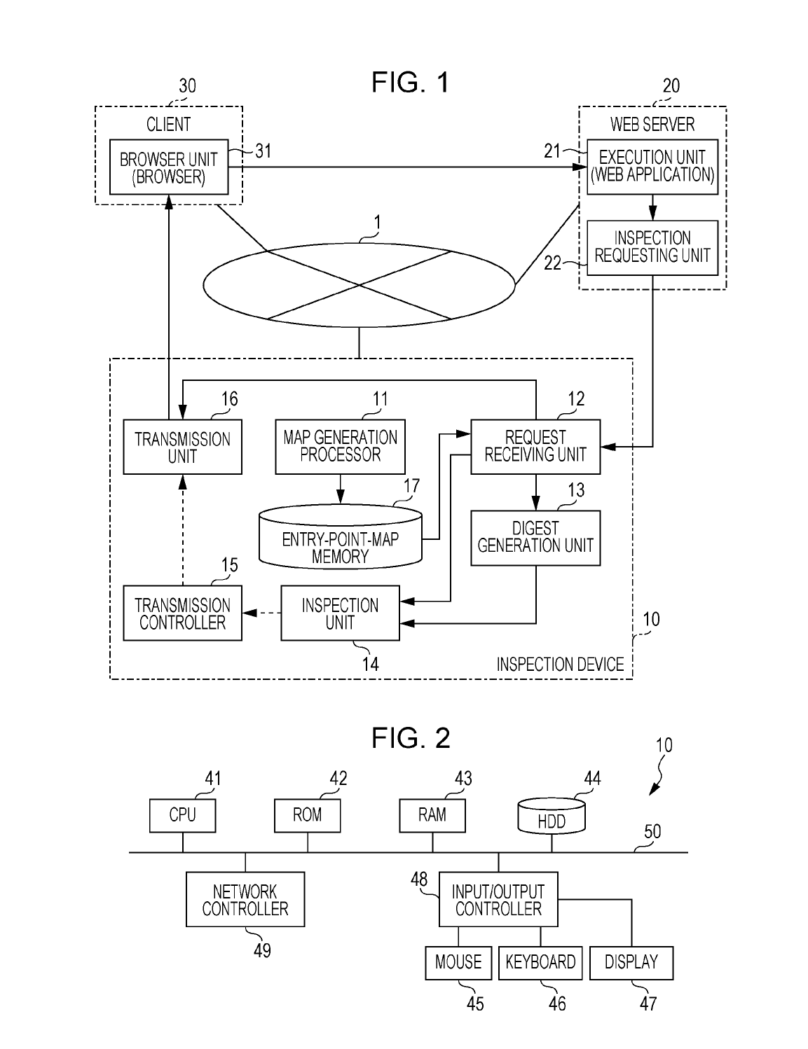

FIG. 1 is a diagram illustrating an overall configuration and a block configuration of a network system including an inspection device 10 in an exemplary embodiment of an information processing apparatus according to the present invention. FIG. 1 illustrates a configuration in which the inspection device 10, a web server 20, and a client 30 are connected to a public network (hereinafter, referred to as a network) 1 such as the Internet. Note that multiple web servers 20 and multiple clients 30 may be connected to the network 1. However, FIG. 1 illustrates only one of the web servers 20 and only one of the clients 30. This is because the web servers 20 have the same configuration, and the clients 30 have the same configuration. The web server 20 is implemented by a general purpose server computer, and one or more executable web applications are installed on the web server 20. The client 30 is a terminal implemented by a general purpose computer such as a personal computer (PC) and has a browser for browsing webpages provided by the web application of the web server 20. The inspection device 10 is implemented by a general purpose computer. The network system in the exemplary embodiment may be implemented by using an existing hardware configuration.

FIG. 2 is a hardware configuration diagram of a computer serving as the inspection device 10 in the exemplary embodiment. In the exemplary embodiment, the computer serving as the inspection device 10 includes a central processing unit (CPU) 41, a read-only memory (ROM) 42, a random-access memory (RAM) 43, a hard disk drive (HDD) 44, an input/output controller 48, and a network controller 49 each of which is connected to an internal bus 50. A mouse 45 and a keyboard 46 that are provided as an input unit and a display 47 provided as a display are connected to the input/output controller 48. The network controller 49 is provided as a communication unit. Since the web server 20 and the client 30 are also computers, their hardware configurations may be illustrated as in FIG. 2.

Referring back to FIG. 1, the client 30 includes a browser unit 31 for browsing webpages provided by the web server 20, the browser unit 31 being implemented by the browser. The web server 20 includes an execution unit 21 and an inspection requesting unit 22. The execution unit 21 executes the web application in response to a request from the client 30. After the web application generates a response in response to the request, the inspection requesting unit 22 pairs the request and the response and transmits the paired request and response to the inspection device 10 to request an inspection of whether the web server 20 has been subjected to an XSS attack. The components that are the browser unit 31, the execution unit 21, and the inspection requesting unit 22 are each implemented through cooperative operations of the corresponding computer and a program run by the CPU installed in the computer.

The inspection device 10 in the exemplary embodiment includes a map generation processor 11, a request receiving unit 12, a digest generation unit 13, an inspection unit 14, a transmission controller 15, a transmission unit 16, and an entry-point-map memory 17. Note that components that are not used for explaining the exemplary embodiment are not illustrated in FIGS. 1 and 2. The same holds true for the web server 20 and the client 30, and such components are thus not illustrated appropriately.

In response to a hypertext transfer protocol (HTTP) request (hereinafter, simply referred to as a request) transmitted from the client 30, the inspection device 10 validates an HTTP response (hereinafter, simply referred to as a response) generated by the web server 20 and thereby inspects whether the web server 20 is damaged by an XSS attack. The map generation processor 11 in advance generates an entry point map to be used for the inspection and registers the entry point map in the entry-point-map memory 17. The entry point map will be described later. The request receiving unit 12 receives, as an inspection request, the paired request and response that are transmitted from the web server 20. The digest generation unit 13 is provided as a generation unit and generates a document object model (DOM) structure pattern of descriptions of the response as a result of parsing the descriptions of the response received by the request receiving unit 12, that is, the response generated by the web server 20 in response to the webpage browsing request (request) actually transmitted from the client 30. In the exemplary embodiment, a DOM structure pattern of a response (a response pattern representing the document structure of a response) is referred to as a digest. The response is described by using a markup language such as a hypertext markup language (HTML).

The inspection unit 14 validates the response received by the request receiving unit 12, by using the digest of the response and the entry point map registered in the entry-point-map memory 17. Specifically, in a case where the digest matches one of forms of an assumed digest (described later) stored in the entry-point-map memory 17 in association with the entry point of the response, the inspection unit 14 determines that the response is valid, that is, the web server 20 has not been subjected to an XSS attack.

The web server 20 transmits, in response to the request from the client 30, a response to cause the client 30 to display a webpage, and descriptions of the response may be assumed from the descriptions of the web application. The response generated by assuming the descriptions of the web application is referred to as an assumed response. Meanwhile, a DOM structure pattern of the assumed response (assumed response pattern) is also a digest. To discriminate the DOM structure pattern of the assumed response from a digest generated by the digest generation unit 13, the DOM structure pattern of the assumed response is referred to as an assumed digest in the exemplary embodiment. A response generated in response to the request from the client 30 is referred to as a real response, and a digest generated on the basis of the real response by the digest generation unit 13 is referred to as a real digest. The assumed digest is set in the entry point map, and the details will be described later.

The transmission controller 15 is provided as a transmission controller. If the inspection unit 14 determines that the response is valid, the transmission controller 15 performs control to transmit the response to the client 30. If the inspection unit 14 determines that the response is not valid, the transmission controller 15 performs control to transmit, to the client 30, notification information indicating that the web server 20 might have been subjected to an XSS attack, instead of transmitting the response generated by the web server 20. The transmission unit 16 transmits the response or the notification information to the client 30 under the control of the transmission controller 15.

The components that are the map generation processor 11 to the transmission unit 16 of the inspection device 10 are implemented through cooperative operations of the computer serving as the inspection device 10 and the program run by the CPU 41 included in the computer. The entry-point-map memory 17 is implemented by the HDD 44 included in the inspection device 10. Alternatively, the RAM 43 or an external memory may be used through the network.

The programs used in the exemplary embodiment may be provided not only by using the communication unit but also in such a manner as to be stored in a computer readable recording medium such as a compact disc read-only memory (CD-ROM) or a universal serial bus (USB) memory. The programs provided from the communication unit or the recording medium are installed in the computers and are run sequentially by the CPUs of the computers to thereby perform various processes.

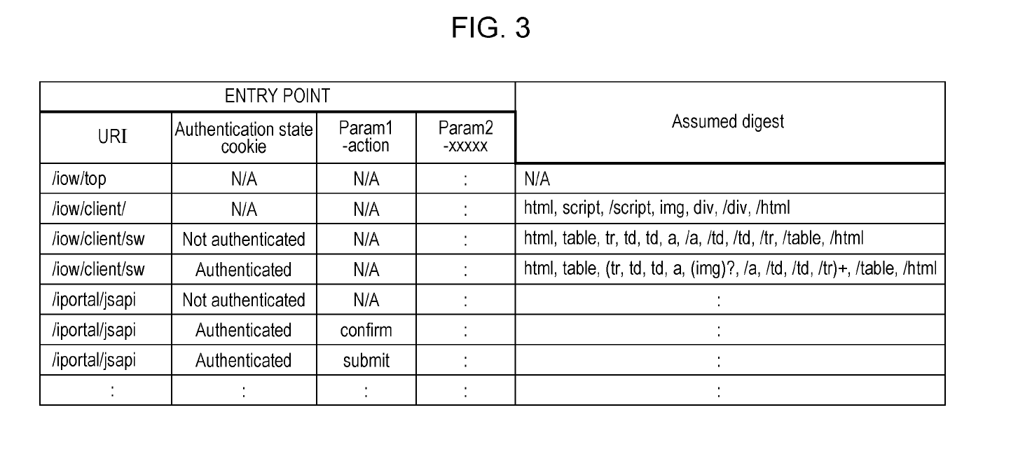

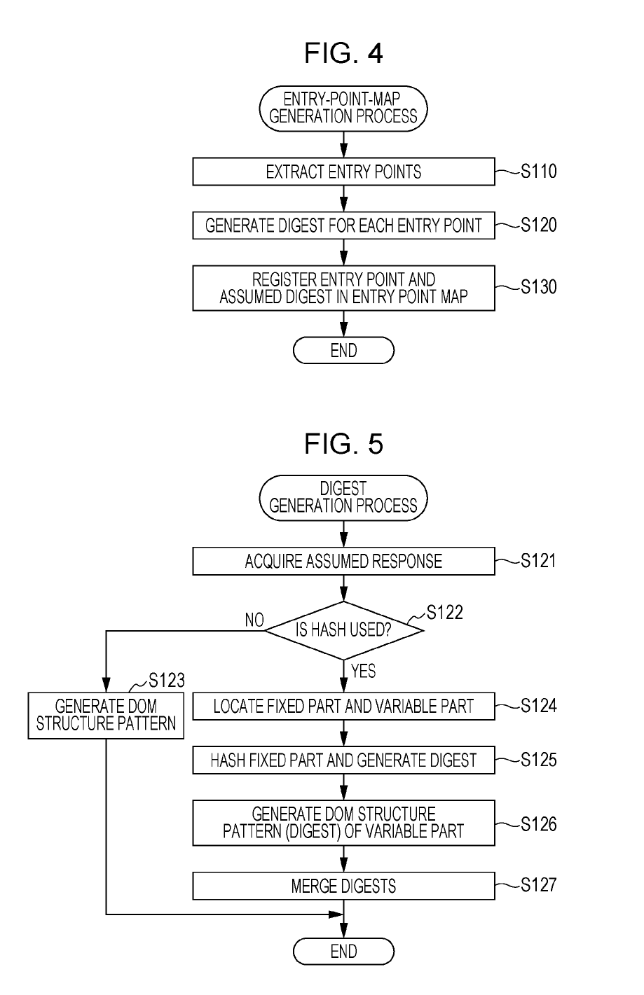

FIG. 3 illustrates an example of the data structure of the entry point map stored in the entry-point-map memory 17 in the exemplary embodiment. FIG. 4 is a flowchart illustrating the entry-point-map generation process performed by the map generation processor 11 in the exemplary embodiment. Hereinafter, the entry point map and the entry-point-map generation process will be described by using FIGS. 3 and 4. The map generation processor 11 is required to generate the entry point map before the inspection device 10 starts the inspection.

An entry point of the web application and an assumed digest are set in the entry point map in association with each other. The entry point is information indicating the position at which a program or the like is started. In the exemplary embodiment, the entry point is expressed by combining a uniform resource identifier (URI) indicating the access destination, an authentication state indicating an access state, such as the presence/absence of a cookie, and one or more request parameters.

The map generation processor 11 acquires and parses the web application run by the web server 20 and extracts entry points included in the web application (S110). Meanwhile, upon receiving a request from the client 30, the execution unit 21 of the web server 20 locates an entry point in the web application on the basis of the descriptions of the request and generates a response on the basis of descriptions following the entry point. Accordingly, the map generation processor 11 assumes that requests corresponding to the respective entry points are transmitted. The map generation processor 11 parses the descriptions following each entry point and thereby generates, for each entry point, a DOM structure pattern of an assumed response, that is, an assumed digest (S120). The map generation processor 11 subsequently registers the entry point and the assumed digest in the entry-point-map memory 17 in association with each other (S130).

Subsequently, the details of the process of generating the assumed digest in step S120 will be described by using the flowchart in FIG. 5.

The map generation processor 11 extracts and acquires, as an assumed response, descriptions following each entry point included in the web application (S121). The map generation processor 11 subsequently displays the assumed response on the display 47. A developer who sets the entry point map refers to the displayed assumed response and determines whether to use a hash. The hash will be described later. The following description is given on the assumption that the developer selects not to use the hash.

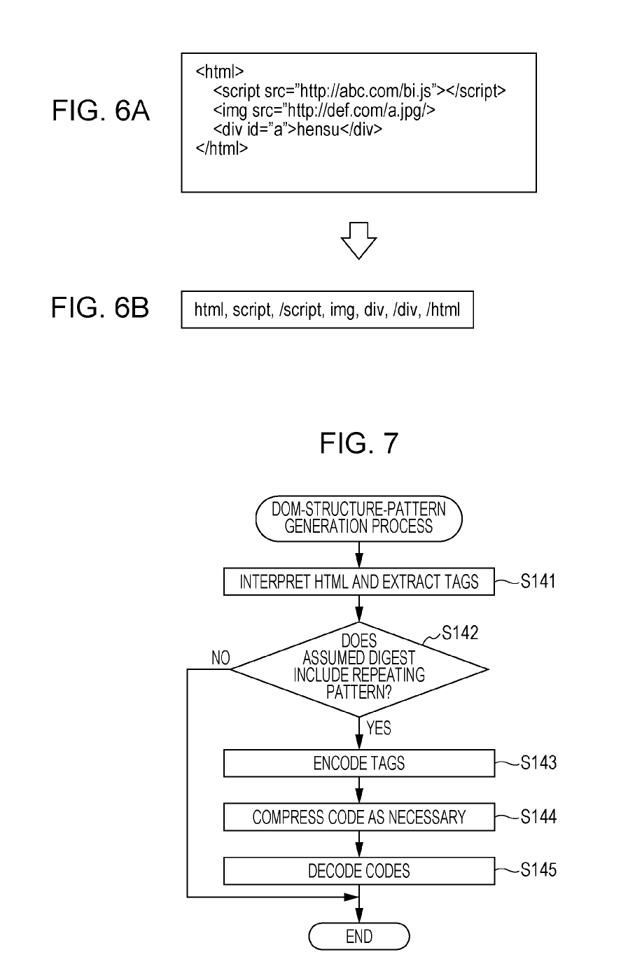

If the map generation processor 11 receives the selection not to use the hash from the developer (NO in S122), the map generation processor 11 uses the assumed response to generate a DOM structure pattern, that is, an assumed digest (S123). How to generate an assumed digest will be described in detail by using FIGS. 6A, 6B, and 7.

FIG. 6A illustrates an example of descriptions starting from a specific entry point, and the descriptions correspond to an assumed response. The assumed response is described using the HTML and thus includes tags such as <html>. The map generation processor 11 extracts all of the tags included in the assumed response in the order of appearance (S141). FIG. 6B illustrates information indicating the extracted tags that are comma-separated. In the exemplary embodiment, a digest is generated in such a manner as to have the tag arrangement as illustrated in FIG. 6B. Note that the assumed response illustrated in FIG. 6A does not include a repeating pattern. A case of including a repeating pattern will be described later.

The map generation processor 11 generates a digest as an assumed digest from the assumed response in this manner. Meanwhile, the digest generation unit 13 generates a digest from a response generated in response to a request from the client 30. Note that in the digest generation process, the digest generation unit 13 also generates a “real digest” in accordance with the processing steps illustrated in FIG. 7.

In the exemplary embodiment, the entry point map is generated as described above. This enables the inspection device 10 to validate a response generated by the web server 20 in response to a request actually transmitted by the client 30.

Next, the flow of a basic process started with request transmission to the web server 20 by the client 30 and ending with response acquisition by the client 30 will be described.

When the web server 20 receives a request transmitted from the client 30, the execution unit 21 locates an entry point in the web application on the basis of the description format of the request and generates a response on the basis of descriptions following the located entry point. After the response is generated, the inspection requesting unit 22 subsequently pairs the request and the response and transmits the paired request and response to the inspection device 10 to request the inspection device to validate the response, in other words, to inspect whether the web server 20 has been damaged by an XSS attack.

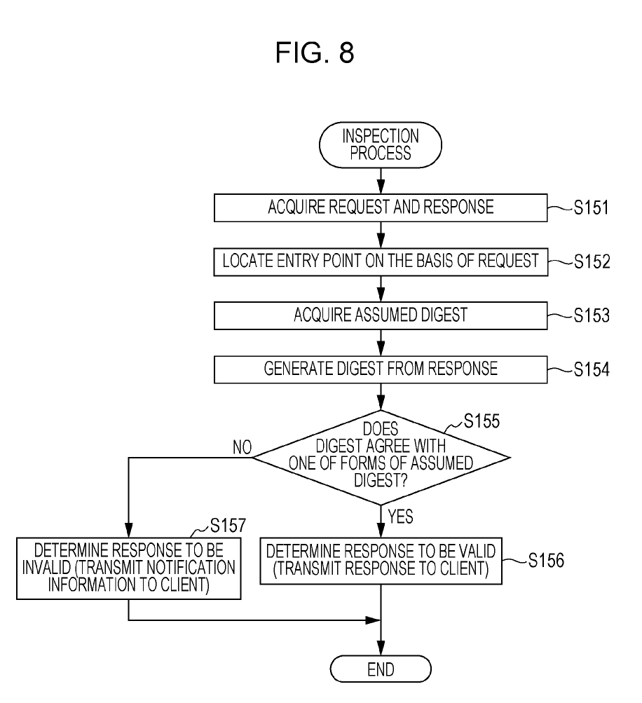

Hereinafter, an inspection process performed by the inspection device 10 in the exemplary embodiment will be described by using a flowchart illustrated in FIG. 8.

Upon receiving the inspection request from the web server 20 by receiving the paired request and response (S151), the request receiving unit 12 locates an entry point corresponding to the received request in the entry point map (S152). The request receiving unit 12 subsequently reads out and acquires an assumed digest associated with the located entry point from the entry point map (S153).

The digest generation unit 13 generates a real digest of a response generated on the basis of the request received by the request receiving unit 12, that is, the request actually transmitted by the client 30 (S154). How to generate a digest has been described by using FIGS. 4 to 7, and thus description thereof is omitted.

After the digest generation unit 13 generates the real digest, the inspection unit 14 compares the assumed digest acquired in step S153 with the real digest generated in step S154. If the digest matches one of forms of the assumed digest (YES in S155), the inspection unit 14 determines that the real response is generated validly in the web server 20 (S156). In the basic inspection process, a case where a real digest matches one of the forms of an assumed digest means a case where descriptions of a real digest match descriptions of an assumed digest. If the real response is determined to be valid, that is, if the real response is validated, the transmission controller 15 instructs the transmission unit 16 to transmit the real response to the client 30. In response to the instruction, the transmission unit 16 transmits the response received by the request receiving unit 12 to the client 30 having transmitted the request.

If the real digest does not match one of forms of the assumed digest (NO in S155), the inspection unit 14 determines that the response generated in the web server 20 is invalid (S157). If the response is determined to be invalid, the transmission controller 15 instructs the transmission unit 16 to transmit, to the client 30, notification information indicating that the web server 20 might have been subjected to an XSS attack. In response to the instruction, the transmission unit 16 transmits the notification information to the client 30 having transmitted the request.

If the client 30 receives the response from the web server 20 via the inspection device 10 after transmitting the request to the web server 20, the browser of the client 30 interprets the descriptions of the response and displays a target webpage on the display. If the client 30 receives the notification information in response to the request, the browser displays the notification information on the display to thereby notify the user that the web server 20 might have been subjected to an XSS attack.

Hereinafter, the foregoing inspection process will be described in detail by using specific examples of the digest.

For example, the assumed response acquired on the basis of the request received in step S151 is described as in FIG. 6A. The map generation processor 11 generates the assumed digest illustrated in FIG. 6B on the basis of the assumed response. Here, suppose a case where the descriptions of the real response received in step S151 are the same as the descriptions of the assumed response in FIG. 6A. In this case, the digest generation unit 13 generates the digest of the real response as in FIG. 6B. As the result, the descriptions of the real digest match the descriptions of the assumed digest (YES in S155), and the real response is thus determined to be valid (S156).

As described above, if the web server 20 has generated a valid response, the descriptions of the response match those of the corresponding assumed response. The real response is thereby validated.

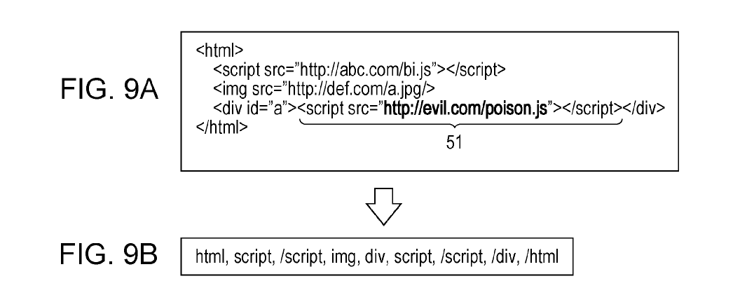

Suppose a case where a response generated in response to an actual request from the client 30 is described as in FIG. 9A. As is clear from a comparison between FIG. 6A and FIG. 9A, it is understood that the generated response includes a description 51 using a <script> tag, instead of hensu in the assumed response. Accordingly, the digest generation unit 13 generates the real digest illustrated in FIG. 9B from the real response illustrated in FIG. 9A (S154). As is clear from a comparison of digests between FIG. 6B and FIG. 9B, the foregoing real digest generated by the digest generation unit 13 includes additional script and /script that are not included in the assumed digest. Accordingly, the real digest and the assumed digest do not match each other. In such a case, the inspection unit 14 determines that the real digest does not match one of forms of the assumed digest (NO in S155) and determines that the real response generated in the web server 20 is invalid (S157).

In the exemplary embodiment as described above, an assumed digest is in advance prepared for each entry point, that is, for each webpage on the basis of the descriptions starting from the entry point. A digest generated from a response generated in response to an actually transmitted request is compared with the corresponding assumed digest, and whether the web server 20 might have been damaged by an XSS attack is thereby determined. In other words, the exemplary embodiment eliminates the need for referring to a result of an actual XSS attack (such as a suspect character string) and enables determination on whether the web server 20 has been subjected to an XSS attack. Accordingly, the exemplary embodiment may be used to address not only reflected XSS but also stored XSS and DOM based XSS.

The basic inspection process in the exemplary embodiment has heretofore been described by taking, as an example, the response descriptions that are simple and do not have a repeated part. Hereinafter, an inspection process for response descriptions having a repeated part will be described. Specifically, steps S143 to S145 in FIG. 7 that have not yet been described above will be described.

In response to a request for displaying a bulletin board, a search result, or a table, data therefore is generally repeatedly displayed in the same display format. In addition, the number of (displayed) data pieces varies depending on request transmission timing or a search condition.

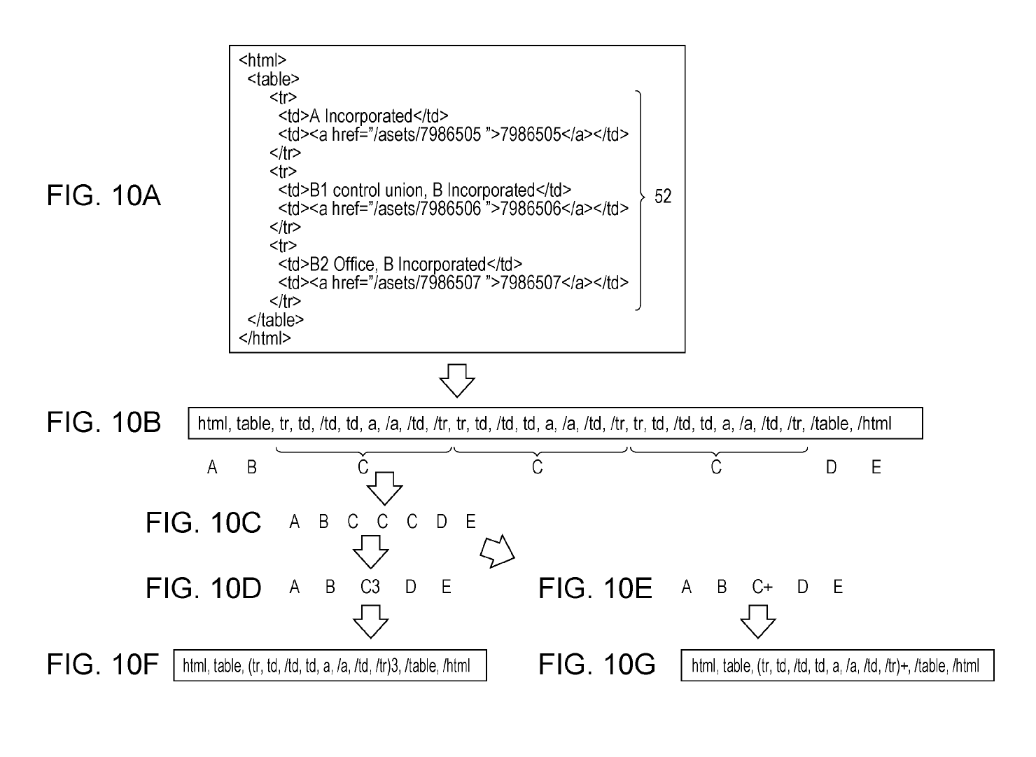

FIG. 10A illustrates an example of an assumed response having a repeated part. A process of generating an assumed digest from the assumed response performed by the map generation processor 11 will be described.

After acquiring an assumed response as a result of parsing descriptions starting from the corresponding entry point extracted from the web application (steps S110 and S120 in FIG. 4 and steps S121 to S123 in FIG. 5), the map generation processor 11 extracts tags from the assumed response (S141). In a case where the assumed digest is described as in FIG. 10A, the map generation processor 11 acquires the assumed digest illustrated in FIG. 10B.

A description 52 in the assumed response is repeated data (a record) displayed in the same format in a table. In a result of parsing the arrangement of tags extracted from the assumed response, tags in the same arrangement pattern appear multiple times. If the assumed digest includes such a repeating pattern (YES in S142), the map generation processor 11 groups the repeating tags in the same arrangement pattern as illustrated in FIG. 10B and assigns a code to the tag group. In the example of codes illustrated in FIG. 10B, a pattern of tr, td, /td, td, a, /a, /td, /tr appears repeatedly and is assigned a code C. Tags such as html and table that are not included in the repeating pattern are individually assigned different codes. The map generation processor 11 encodes tags included in the assumed digest acquired from the assumed response (S143). FIG. 10C illustrates the encoded assumed digest.

Subsequently, the map generation processor 11 parses the encoded assumed digest and compresses the codes as necessary (S144). In the encoded assumed digest illustrated in FIG. 10C, three Cs appear in succession. In the exemplary embodiment, the three Cs are considered to be in the same pattern and thus compressed into C3 as illustrated in FIG. 10D. Thereafter, the map generation processor 11 expands the codes to tags by decoding (S145). If the assumed digest does not include a repeating pattern (NO in S142), the process is terminated.

As described above, if a repeating tag pattern is present in the assumed digest acquired from the assumed response (FIG. 10B), the map generation processor 11 edits the assumed digest, compresses the repeating pattern as described above, decodes elements in the repeated part as illustrated in FIG. 10F, and thereby generates an assumed digest. As is clear from FIG. 10F, in the exemplary embodiment, the repeated part is described in accordance with a predetermined description rule in which the repeated part is put in parentheses and ) is followed by the number of appearances of the repeated part.

Another way of compressing the encoded assumed digest may be used in step S144. Specifically, the three Cs may be compressed into C+ indicating that C appears multiple times as illustrated in FIG. 10E, without limiting the number of appearances of C to 3. FIG. 10G illustrates an assumed digest generated as the result of decoding this. As is clear from FIG. 10G, the repeating pattern is described in accordance with a predetermined rule in which + representing one or more appearances is used to express the number of appearances, without fixing the number of appearances of the repeated part by using a numerical value of “3” as in FIG. 10F.

In the assumed response illustrated in FIG. 10A, the repeating pattern appears three times. It is easily conceivable that the number of retrieved data pieces might vary depending on the search condition or the like. Hence, instead of explicitly describing the number of appearances as 3 by using C3, a code of + indicating one or more appearances is added to C. The assumed digest is generated in the format indicating that the number of times the repeating pattern appears may vary, that is, is variable.

Nevertheless, explicitly describing the number of appearances by using Cn (n is a natural number) such as C3 has a merit. For example, to display data to be repeated fixed times, such as blood types or prefectures, it is favorable to generate an assumed digest in such a manner that the number of appearances is fixed by using Cn. For example, since the blood types are four fixed types A, B, O, and AB, C4 is used. In this case, if the number of appearances of blood-type data in a real digest for displaying the blood-type data is not 4, for example, if the number of appearances is 5, it may be assumed that the web server 20 might have been damaged by an XSS attack.

In the description above, alphabetical letters are assigned to the tags and the repeating pattern, and the code + is added to the repeating pattern. However, the codes are examples, and different codes may be used in accordance with a predetermined description rule. In addition, the examples of the cases where the numbers of appearances are fixed and variable have been described in the exemplary embodiment, but upper and lower limits or a range may be used to designate the number of appearances. In this case, when the entry point map is generated, the assumed digest automatically generated by the map generation processor 11 as in FIG. 10F or FIG. 10G may be displayed on the display 47 to prompt the developer to edit the assumed digest.

Next, an inspection process performed by the inspection device 10 in a case where a response generated in response to a request actually transmitted from the client 30 has a repeating pattern will be described by using FIG. 8. Note that the steps already described are appropriately omitted.

The request receiving unit 12 acquires an assumed digest on the basis of received paired request and response (S151 to S153). The digest generation unit 13 subsequently generates a real digest of the response received by the request receiving unit 12 (S154).

Subsequently, the inspection unit 14 compares the assumed digest acquired in step S153 with the real digest generated in step S154. The inspection unit 14 may recognize that the assumed digest includes a repeating pattern by referring to the assumed digest (for example, FIG. 10G). In this case, the inspection unit 14 finds, in the real digest, the tag arrangement corresponding to the repeated part in the assumed digest and verifies the descriptions of the repeated part in the real digest on the basis of the foregoing code of 3 or + following ).

For example, suppose a case where the tag arrangement corresponding to the code C in FIG. 10B appears five times in the real digest. In this case, if the assumed digest is generated as in FIG. 10F, the tag arrangement in the real digest matches the tag arrangement in the assumed digest, but the number of appearances is not 3. Accordingly, the real digest is determined to be invalid. In contrast, if the assumed digest is generated as in FIG. 10G, the tag arrangement in the part designated as the repeating pattern in the real digest matches the tag arrangement in the assumed digest. Accordingly, the real digest is determined to be valid.

In the case of the simple assumed response that does not include the repetition as illustrated in FIG. 6A, the real digest is required to completely match the assumed digest. In contrast, if the digest described herein includes the repeating pattern, the descriptions of the real digest do not completely match the descriptions of the assumed digest. However, the content of the descriptions of the real digest matches the content intended by the descriptions of the assumed digest that conform to a description rule. In the exemplary embodiment as described above, in a case where the descriptions of the real digest have the same content as the content intended by the assumed digest described in accordance with a predetermined description rule, the descriptions of the real digest are considered to match one of the forms of the assumed digest.

As described above, if the descriptions of the real digest match one of forms of the assumed digest (YES in S155), specifically, if the descriptions except the repeated part in the real digest match the descriptions of the assumed digest, and if the content of the descriptions in the repeated part in the real digest matches the content of the descriptions of the assumed digest that conform to the predetermined description rule, the inspection unit 14 determines that the response has been generated validly in the web server 20 (S156). On the other hand, if the descriptions of the real digest do not match one of forms of the assumed digest (NO in S155), the inspection unit 14 determines that the response generated in the web server 20 is invalid (S157).

In the exemplary embodiment, the real digest is compared with the assumed digest compressed in step S144 and thereafter decoded in step S145. However, a real response may be encoded and compressed in steps S143 and S144, and a real digest thus obtained may be compared with the assumed digest.

Hereinafter, a modification of the case where the response includes a repeating pattern will be described.

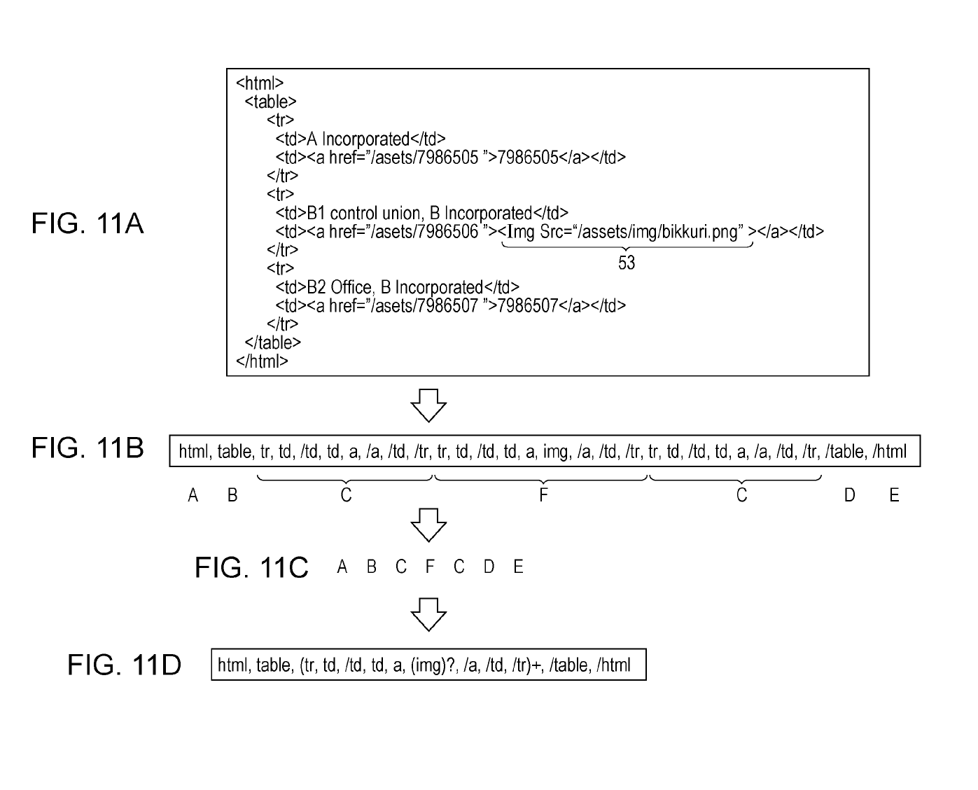

FIG. 11A illustrates an assumed response having a repeating pattern, like FIG. 10A. However, FIG. 11A illustrates a case where a specific description is included in one of strings each corresponding to a repeated part of an assumed response but is not included in the other strings. Specifically, a description 53 using an img tag appears in only one of the strings corresponding to the repeated part. Except for the description 53, the assumed response illustrated in FIG. 11A has a repeating pattern of tr, td, /td, td, a, /a, /td, /tr. Basically, an assumed digest may be generated in the same manner as in FIGS. 10A to 10G. However, in this example, as illustrated in FIG. 11D, the assumed digest is generated in accordance with a predetermined description rule in which the tag img that might appear locally is put in parentheses and ) is followed by ?, such as (img)?. The assumed digest illustrated in FIG. 11D may also be completed, for example, in such a manner that when the entry point map is generated, the assumed digest automatically generated as in FIG. 11B by the map generation processor 11 is displayed on the display 47 to prompt the developer to edit the assumed digest.

Subsequently, another example of generating a digest will be described. Specifically, steps S124 to S127 in FIG. 5 that have not yet been described will be described.

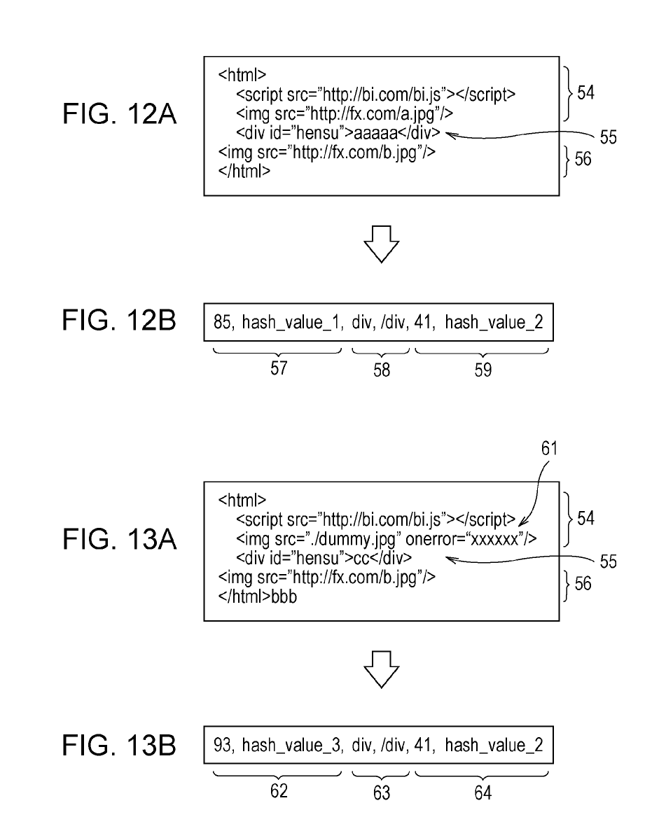

Like the repeating pattern described above, the descriptions in the response are likely to have a fixed part in addition to the variable part. FIG. 12A illustrates an example of an assumed response. An assumed response might have a mixture of a fixed description 54 and a variable description 55 as illustrated in FIG. 12A. To generate an assumed digest, all the tags may be extracted from the assumed response as described above, but strings each forming a fixed part of the descriptions may be collectively processed.

Hereinafter, an entry-point-map generation process performed by the map generation processor 11 in such a manner that descriptions of the assumed response are separated into a fixed part and a variable part will be described.

The map generation processor 11 acquires an assumed response as a result of parsing descriptions starting from the corresponding entry point extracted from the web application (steps S110 and S120 in FIG. 4 and step S121 in FIG. 5).

If the map generation processor 11 receives a selection to use a hash from the developer (YES in S122), the map generation processor 11 displays the assumed response on the display 47 to prompt the developer to designate a fixed part and a variable part. The map generation processor 11 receives the designation and thereby extracts the fixed part and the variable part in the assumed response (S124). In the assumed response illustrated in FIG. 12A, the description 54 and a description 56 correspond to the fixed part, and the description 55 corresponds to the variable part. Subsequently, the map generation processor 11 calculates a hash value for each of the descriptions 54 and 56 that are the fixed parts (S125). In the exemplary embodiment, the number of bytes from a tag (digest) immediately before a hash target that is a description of the corresponding fixed part and the hash value are used to generate a digest corresponding to the fixed part. Since the description 54 is the first description in the assumed response, the number of bytes from the first position is 85. A digest corresponding to the fixed part is generated by using 85 and a hash value (hash_value_1) calculated by using the 85-byte description 54 as a hash target. For the description 56, the number of bytes of 41 from a tag (digest) /div immediately before the description 56 and a hash value (hash_value_2) calculated by using the 41-byte description 56 as a hash target are used to generate a digest corresponding to the fixed part.

Subsequently, the map generation processor 11 extracts, as described in step S123, all the tags from the description 55 that is the variable part and generates a DOM structure pattern (S126). The generated DOM structure pattern is used for a digest for the corresponding variable part. After the digests are generated for the fixed parts and the variable part in this manner, the digests are merged together to complete an assumed digest (S127). Note that step S125 and step S126 may be performed in the inverted order.

FIG. 12B illustrates the assumed digest generated in the process described above. Descriptions 57, 58, and 59 in the assumed digest correspond to the descriptions 54, 55, and 56 in the assumed response, respectively.

Next, an inspection process performed by the inspection device 10 by using an assumed digest including a hash value will be described by using FIG. 8. Note that descriptions of the steps already described are appropriately omitted.

The request receiving unit 12 acquires an assumed digest on the basis of the received paired request and response (S151 to S153). The digest generation unit 13 subsequently generates a digest of the response received by the request receiving unit 12. At this time, the digest generation unit 13 may recognize that the assumed digest includes at least one hash value by referring to the assumed digest (for example, FIG. 12B). The digest generation unit 13 generates a real digest using the hash on the basis of the real response as in the same manner as in steps S124 to S127 in FIG. 5 (S154).

Subsequently, the inspection unit 14 compares the assumed digest acquired in step S153 with the real digest generated in step S154. If the real digest matches one of forms of the assumed digest (YES in S155), the inspection unit 14 determines that the response is generated validly in the web server 20 (S156). When a hash is used in descriptions, a case where a real digest matches one of forms of an assumed digest means a case where descriptions using the hash in a real digest match descriptions of the corresponding assumed digest. When a hash is not used in descriptions, the case where a real digest matches one of forms of an assumed digest means the case as described for the cases where a response includes simple descriptions and where a response includes a repeating pattern. On the other hand, if the real digest does not match one of forms of the assumed digest (NO in S155), the inspection unit 14 determines that the response generated in the web server 20 is invalid (S157).

FIG. 13A illustrates an example of the real response generated in the web server 20. As is clear from a comparison with the assumed response illustrated in FIG. 12A, a description 54 in the real response illustrated in FIG. 13A includes a description 61 that is not included in the assumed response. Due to the description 61, the number of bytes and a hash value that are calculated for the description 54 in the real response are different from those in the assumed response. As illustrated in FIG. 13B, a digest 62 for the description 54 is different from the corresponding assumed digest 57.

According to the exemplary embodiment, the real digest of the response generated in response to the request from the client 30 is verified by making a comparison with the assumed digest prepared in advance. This enables inspection of whether the web server 20 is damaged by an XSS attack.

In the exemplary embodiment, the transmission controller 15 instructs the transmission unit 16 to transmit the response generated by the web server 20 from the inspection device 10 to the client 30. However, the transmission controller 15 may instruct the web server 20 to transmit the response back to the client 30. The same holds true for the notification information.

In the exemplary embodiment, the inspection device 10 is provided separately from the web server 20 but may be integrated with the web server 20 by providing the web server 20 with a processing function of the inspection device 10. Alternatively, the inspection device 10 may be designed to perform inspection for the multiple web servers 20, without a one-to-one correspondence relationship with the web server 20.

The foregoing descriptions of the exemplary embodiment of the present invention has been provided for the purposes of illustration and descriptions. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores, on a per webpage basis, an assumed response pattern representing a document structure of a response that is to be generated by a web server in response to a webpage browsing request and that is to be described in a markup language, the assumed response pattern being generated as a result of parsing an assumed description of the response;
a generation unit that generates a response pattern representing a document structure of a response that is generated by the web server in response to a webpage browsing request transmitted from a client and that is described in the markup language, the response pattern being generated as a result of parsing a description of the response; and
a transmission controller that performs control such that in a case where the response pattern generated by the generation unit matches a form of an assumed response pattern stored in the memory in association with a webpage that is a target of the webpage browsing request transmitted from the client, the response generated by the web server in response to the webpage browsing request transmitted from the client is transmitted to the client.

2. The information processing apparatus according to claim 1,
wherein an element that is likely to be repeatedly included in the response to be generated by the web server is encoded in accordance with a predetermined description rule, and the encoded element is described in the assumed response pattern.

3. The information processing apparatus according to claim 1,
wherein in a case where a fixed description in the response to be generated by the web server is described in an encoded manner in accordance with a predetermined description rule in the assumed response pattern, and in a case where a fixed description is included in the response generated by the web server in response to the webpage browsing request from the client, the generation unit encodes the fixed description included in the generated response in accordance with the description rule and generates the response pattern.

4. The information processing apparatus according to claim 1,
wherein in a case where the response pattern generated by the generation unit does not match a form of the assumed response pattern associated with the webpage that is the target of the webpage browsing request transmitted from the client, the transmission controller performs control to transmit, to the client, notification information indicating a possibility that the web server has been attacked, instead of the response generated by the web server.

5. A network system comprising:
a client that transmits a webpage browsing request;
a web server that generates, in response to the webpage browsing request transmitted from the client, a response described in a markup language;
an information processing apparatus; and
a memory that stores, on a per webpage basis, an assumed response pattern representing a document structure of a response that is to be generated by the web server in response to a webpage browsing request and that is to be described in the markup language, the assumed response pattern being generated as a result of parsing an assumed description of the response,
wherein the web server includes an inspection requesting unit that requests an inspection of the web server by transmitting, to the information processing apparatus, the webpage browsing request transmitted from the client and the response generated in response to the webpage browsing request, and
wherein the information processing apparatus includes
a request receiving unit that receives the webpage browsing request and the response that are transmitted when the web server requests the inspection,
a generation unit that parses a description of the response received by the request receiving unit and generates a response pattern representing a structure of the response, and
a transmission controller that performs control such that in a case where the response pattern generated by the generation unit matches a form of an assumed response pattern stored in the memory in association with a webpage that is a target of the webpage browsing request transmitted from the client, the response generated by the web server in response to the webpage browsing request transmitted from the client is transmitted to the client.

6. A non-transitory computer readable medium storing a program causing a computer to execute a process, the computer enabled to access a memory that stores, on a per webpage basis, an assumed response pattern representing a document structure of a response that is to be generated in response to a webpage browsing request and that is to be described in a markup language, the assumed response pattern being generated as a result of parsing an assumed description of the response, the process comprising:
generating a response pattern representing a document structure of a response that is generated in response to a webpage browsing request transmitted from a client and that is described in the markup language, the response pattern being generated as a result of parsing a description of the response; and
performing control such that in a case where the generated response pattern matches a form of an assumed response pattern stored in the memory in association with a webpage that is a target of the webpage browsing request transmitted from the client, the response generated in response to the webpage browsing request transmitted from the client is transmitted to the client.
